(19) United States
(12) Patent Application Publication
(10) Pub. No.: US 2018/0197352 A1
(43) Pub. Date: Jul. 12, 2018

(54) VEHICLE CONFIGURED TO AUTONOMOUSLY PROVIDE ASSISTANCE TO ANOTHER VEHICLE

(71) Applicant: Faraday&Future Inc., Gardena, CA (US)

(72) Inventors: Veera Ganesh Ganesh, Sunnyvale, CA (US); Jan Becker, Palo Alto, CA (US); Juergen Heit, Mountain View, CA (US)

(21) Appl. No.: 15/662,640

(22) Filed: Jul. 28, 2017

Related U.S. Application Data
(60) Provisional application No. 62/368,744, filed on Jul. 29, 2016.

(51) Int. Cl. G07C 5/00; G06K 9/00; H04W 4/46; B60W 50/00

(52) U.S. Cl. CPC G07C 5/008; G06K 9/00825; B60W 2550/408; H04W 4/46; B60W 50/0098; G07C 5/006

(57) ABSTRACT

A first vehicle comprising one or more sensors configured to sense one or more characteristics of surroundings of the first vehicle, one or more cameras configured to capture images of the surroundings of the first vehicle, and one or more processors coupled to the one or more sensors and the one or more cameras. The one or more processors are configured to identify a second vehicle as a distressed vehicle using outputs from at least one of the one or more sensors and the one or more cameras, determine one or more trouble items associated with the distressed vehicle, and in response to determining the one or more trouble items, perform a set of one or more actions to assist the distressed vehicle based on the determined one or more trouble items.

### CROSS-REFERENCE TO RELATED APPLICATIONS

This application claims the benefit of U.S. Provisional Application No. 62/368,744, filed Jul. 29, 2016, the entirety of which is hereby incorporated by reference.

### FIELD OF THE DISCLOSURE

This relates generally to providing assistance to a vehicle, and more particularly to a vehicle that is configured to autonomously provide such assistance to another vehicle.

### BACKGROUND OF THE DISCLOSURE

Vehicles, especially automobiles, increasingly include various cameras and sensors for performing autonomous or semi-autonomous actions, such as autonomous driving maneuvers. Such vehicles can also include the capability to communicate with other vehicles (e.g., via vehicle-to-vehicle communication systems) and/or with third parties.

### SUMMARY OF THE DISCLOSURE

Examples of the disclosure are directed to using one or more cameras and/or sensors on a vehicle to autonomously determine that another vehicle is in distress (e.g., is damaged, has been involved in an accident, etc.). Upon making such a determination, the vehicle of the disclosure can autonomously provide assistance to the distressed vehicle in various ways, as appropriate, including performing actions to directly assist the distressed vehicle and/or transmitting information to a third party for assisting the distressed vehicle.

### BRIEF DESCRIPTION OF THE DRAWINGS

FIG. 1 illustrates an exemplary scenario in which an aid vehicle can identify that a distressed vehicle is in need of assistance according to examples of the disclosure.

FIG. 2 illustrates an exemplary method of an aid vehicle performing a corrective action to assist a distressed vehicle according to examples of the disclosure.

FIG. 3 illustrates an exemplary method of an aid vehicle providing, to one or more third parties, relevant information for assisting a distressed vehicle according to examples of the disclosure.

FIG. 4 illustrates an exemplary system block diagram of vehicle control system according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples. Further, in the context of this disclosure, “autonomous driving” (or the like) can refer to either autonomous driving, partially autonomous driving, and/or driver assistance systems.

Vehicles, especially automobiles, increasingly include various cameras and sensors for performing autonomous or semi-autonomous actions, such as autonomous driving maneuvers. Such vehicles can also include the capability to communicate with other vehicles (e.g., via vehicle-to-vehicle communication systems) and/or with third parties. Examples of the disclosure are directed to using one or more cameras and/or sensors on a vehicle to autonomously determine that another vehicle is in distress (e.g., is damaged, has been involved in an accident, etc.). Upon making such a determination, the vehicle of the disclosure can autonomously provide assistance to the distressed vehicle in various ways, as appropriate, including performing actions to directly assist the distressed vehicle and/or transmitting information to a third party for assisting the distressed vehicle.

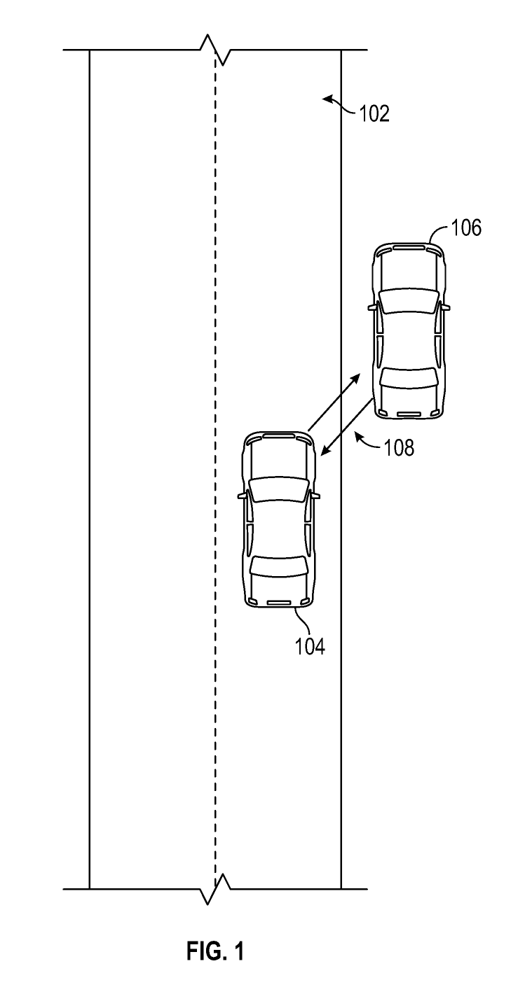

FIG. 1 illustrates an exemplary scenario in which vehicle 104 can identify that vehicle 106 is in need of assistance according to examples of the disclosure. Vehicle 104 can be traveling on road 102. In some examples, vehicle 104 can be an autonomous automobile or any other vehicle, and in some examples, vehicle 104 can include various components or sensors for determining one or more characteristics of its surroundings, such as cameras, ultrasonic sensors, radar, LiDAR sensors, etc. Vehicle 106 can be a vehicle that is at least partially nonoperational on the side of road 102. For example, vehicle 106 can have been involved in an accident, the battery of vehicle 106 may be discharged, or vehicle 106 may be experiencing any other ailment that prevents vehicle 106 from operating at its full capabilities. In some examples, a driver or passenger of vehicle 106 may be wounded or otherwise incapacitated.

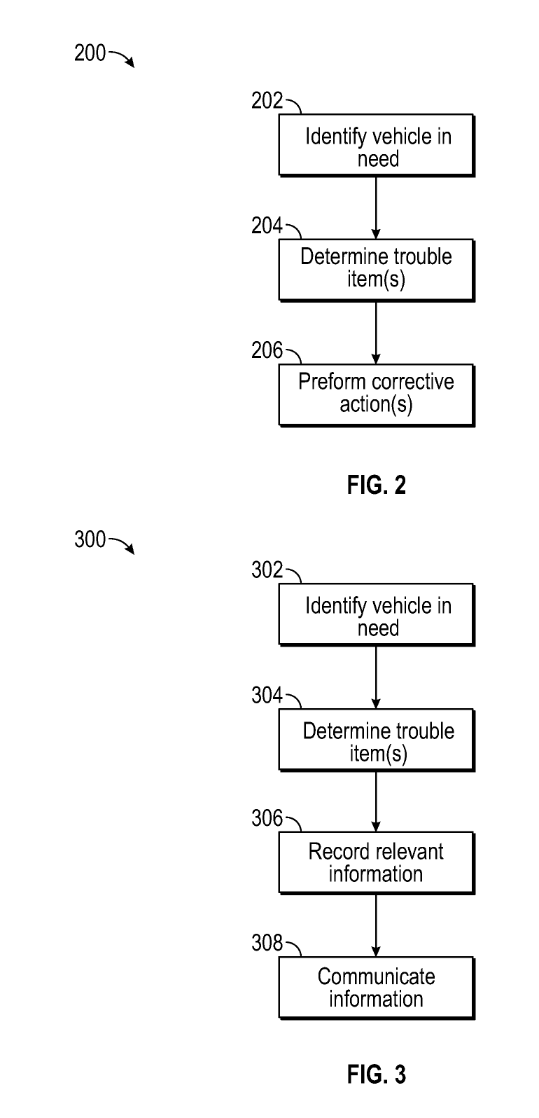

In some examples, vehicle 104 can autonomously determine that vehicle 106 is in need of assistance and/or that one or more occupants of vehicle 106 are incapacitated. For example, vehicle 104 can utilize one or more of its sensor systems (e.g., optical cameras, LiDAR, ultrasonic sensors, etc.) to determine that vehicle 106 is in need of assistance and/or that one or more occupants of vehicle 106 are incapacitated. In some examples, vehicle 104 can be in communication with vehicle 106, such as via a wireless vehicle-to-vehicle connection 108. In such circumstances, vehicle 104 can utilize information received from vehicle 106 to determine that vehicle 106 is in need of assistance and/or that one or more occupants of vehicle 106 are incapacitated. Additional details will be provided with reference to FIGS. 2-3, below.

In response to determining that vehicle 106 is in need of assistance and/or that one or more occupants of vehicle 106 are incapacitated, vehicle 104 can autonomously (e.g., without user input) take appropriate action based on the determination. For example, vehicle 104 can communicate data to vehicle 106 (e.g., via connection 108) to configure or otherwise control one or more aspects of vehicle 106, as will be described in more detail with reference to FIGS. 2-3, below. In some examples, vehicle 104 can record information about vehicle 106 and/or its occupants (e.g., images, the extent of damage, etc.), and can communicate that information to an appropriate third party (e.g., police, firefighters, an ambulance, paramedics, emergency responders, a gas station, etc.) so that the third party can be informed of the state of vehicle 106 and/or its occupants. In some examples, vehicle 104 can, itself, aid vehicle 106. For example, if the battery of vehicle 106 is discharged, vehicle 104 can autonomously determine as much, and can prepare its systems to charge the battery of vehicle 106 (e.g., vehicle 104 can automatically position itself correctly with respect to vehicle 106, vehicle 104 can provide access to power terminals for use by vehicle 106 and/or its occupants, etc.). As such, vehicle 104 (e.g., an “aid vehicle”) can autonomously determine the state of vehicle 106 (e.g., a “distressed vehicle”) and/or its occupants, and can take appropriate action. Additional details will be provided with reference to FIGS. 2-3, below.

FIG. 2 illustrates an exemplary method 200 of an aid vehicle performing a corrective action to assist a distressed vehicle according to examples of the disclosure. Method 200, and the examples of the disclosure, will be described in the context of a single aid vehicle and a single distressed vehicle; however, it is understood that the examples of the disclosure can apply analogously to multiple aid vehicles and/or multiple distressed vehicles. At step 202, the aid vehicle can determine that one or more other vehicles are in need of assistance (“distressed vehicles”). In some examples, this determination can include determining that the other vehicle is not fully operational, and in some examples, this determination can include determining that one or more occupants of the other vehicle are in need of assistance (e.g., injured or otherwise incapacitated).

The aid vehicle can determine that a distressed vehicle is in need of assistance in many different ways. For example, the aid vehicle can use one or more optical cameras included in the aid vehicle in conjunction with image recognition capabilities to determine that the distressed vehicle is in need of assistance (e.g., determining that the distressed vehicle has been involved in an accident). In some examples, the aid vehicle can receive a distress communication from the distressed vehicle that can indicate to the aid vehicle that the distressed vehicle is in need of assistance. In some examples, the aid vehicle and the distressed vehicle can have vehicle-to-vehicle communication capabilities (e.g., via wireless communication hardware), and an indication that assistance is needed can be sent by the distressed vehicle to the aid vehicle using such communication capabilities. In some examples, deep machine learning and/or neural networks can be utilized at step 202 to facilitate accurate determination that the distressed vehicle is in need of assistance.

At step 204, the aid vehicle can determine one or more trouble items (e.g., operational failures of one or more components of the distressed vehicle) associated with the distressed vehicle. In some examples, the aid vehicle can automatically determine these trouble items without user intervention. For example, the aid vehicle can use image recognition techniques on images captured by one or more cameras included in the aid vehicle to determine that the distressed vehicle has a flat tire. In some examples, the aid vehicle can use vehicle-to-vehicle communication capabilities to directly communicate with the distressed vehicle, and can determine one or more trouble items associated with the distressed vehicle in this way. For example, the aid vehicle can request information about trouble items from the distressed vehicle, which can provide such information to the aid vehicle, as appropriate. In some examples, the aid vehicle can access an electronic control unit (ECU) of the distressed vehicle, via which the aid vehicle can determine trouble items on the distressed vehicle. For example, an ECU of the distressed vehicle can have information about various systems in the distressed vehicle that have failed, and the aid vehicle can automatically access that information (e.g., wirelessly) to determine such failures.

Additional examples of trouble items associated with the distressed vehicle are also contemplated. For example, the aid vehicle can determine that the battery of the distressed vehicle has been discharged and requires a jump start. In some examples, the aid vehicle can determine that the battery of a mobile phone (or other electronic device) of an occupant of the distressed vehicle is discharged and requires recharging. In some examples, the aid vehicle can determine that the distressed vehicle is out of gas. In some examples, the aid vehicle can determine that a fire is active in the distressed vehicle (e.g., using one or more of pressure sensors, thermometers and cameras included in the aid vehicle and/or the distressed vehicle). In some examples, the aid vehicle can determine that a fire is active in the distressed vehicle if one or more sensors in the distressed vehicle suddenly cease functioning (e.g., cease functioning within a threshold amount of time). In some examples, the aid vehicle can identify fluid (e.g., cooling, brake, battery, etc.) leaks in various systems of the distressed vehicle. In some examples, the aid vehicle can determine that an occupant of the distressed vehicle needs transportation to a given destination (e.g., by identifying a destination that had been previously set by the occupant into the navigation system of the distressed vehicle).

At step 206, the aid vehicle can, itself, perform the appropriate corrective action(s) to address the trouble item(s) determined at step 204. In some examples, before performing such corrective actions, the aid vehicle can require validation of one or more occupants of the distressed vehicle to help ensure that the distressed vehicle and/or occupants are, indeed, in need of assistance, and that the occupants are not frivolously requesting assistance from the aid vehicle. For example, such validation can include requiring an occupant to input identifying information (e.g., driver's license information, biometric identifying information, etc.) before performing the corrective action(s).

The aid vehicle, at step 206, can perform various corrective actions to respond to the needs of the distressed vehicle determined at step 204. In some examples, the aid vehicle may only respond to the distressed vehicle if the actions needed to address the trouble items in the distressed vehicle are within the aid vehicle's capabilities; otherwise, after step 204, the aid vehicle may not respond to the distressed vehicle. For example, upon determining that the mobile phone of an occupant of the distressed vehicle needs charging, the aid vehicle can provide the occupant of the distressed vehicle with access to a charging port (e.g., an external universal serial bus (USB) charging port) on the aid vehicle so that the occupant of the distressed vehicle can charge their mobile phone. However, if the aid vehicle has insufficient battery power to spare for charging the mobile phone, the aid vehicle can forgo providing access to such a charging port. As another example, if the distressed vehicle is out of gas, the aid vehicle can offer to drive an occupant of the distressed vehicle to and from a nearby gas station. In some examples, if the distressed vehicle needs a jump start, the aid vehicle can automatically provide access to battery or other terminals on the aid vehicle that can be used to jump start the distressed vehicle. In some examples, if the aid vehicle determines that a destination has been set in the navigation system of the distressed vehicle, the aid vehicle can offer to transport the occupant(s) of the distressed vehicle to that destination.

In some examples, the aid vehicle can guide one or more occupants of the distressed vehicle through various medical treatments and/or automotive repairs that can be performed to at least partially treat the occupant(s) of the distressed vehicle and/or at least partially restore functionality to the distressed vehicle. In some examples, the aid vehicle may only provide such guidance if the required treatments/repairs are relatively simple; otherwise, the aid vehicle may forgo providing such guidance. For example, based on the determinations of the trouble item(s) made at step 204, at step 206, the aid vehicle can search for various solutions to those trouble items (e.g., via an internet connection at the aid vehicle), and can convey such solutions to the occupants of the distressed vehicle (e.g., via one or more displays included in the aid vehicle). For example, the aid vehicle can provide instructions to an occupant of the distressed vehicle as to how to jump start the distressed vehicle and/or change a tire on the distressed vehicle, as appropriate. As another example, the aid vehicle can transmit a command (e.g., wirelessly) to the distressed vehicle to selectively decouple the battery of the distressed vehicle from one or more systems of the distressed vehicle to prevent further damage or dangerous conditions that could result from continued delivery of power to those one or more systems (e.g., cutting power from the battery of the distressed vehicle to the airbag system of the distressed vehicle to prevent the airbags of the distressed vehicle from unintentionally deploying). In some examples, the aid vehicle can transmit one or more commands to the distressed vehicle to selectively shut down systems on the distressed vehicle to prevent additional dangerous conditions from developing (e.g., shutting down fluid pump systems, such as fuel or brake fluid pumps, to prevent fluid leaks).

In some examples, the systems of the aid vehicle can be used in conjunction with the systems of the distressed vehicle to take appropriate actions. For example, the aid vehicle and the distressed vehicle can communicate wireless to “pool” their systems in such a way that one or more systems on the aid vehicle can be substituted for one or more systems on the distressed vehicle that may be nonoperational. In some examples, the systems on the aid vehicle can include systems such as GPS, LiDAR, radar, ultrasonic, etc. Additionally, in some examples, the distressed vehicle can communicate, to the aid vehicle, which of its systems are nonoperational (e.g., cameras, LiDAR, radar, etc.), and the aid vehicle can provide the distressed vehicle access to its systems to fill-in for those nonoperational systems on the distressed vehicle. Thus, for example, if the LiDAR system on the distressed vehicle is nonoperational, the aid vehicle can share data from its LiDAR system(s) with the distressed vehicle so that the distressed vehicle can have access to LiDAR data and can act accordingly. The aid vehicle can similarly share access to others of its various systems with the distressed vehicle. In this way, the aid vehicle can safely “guide” or “virtually tow” the distressed vehicle to a repair location, despite the fact that the distressed vehicle may be operating with one or more nonoperational systems.

The examples described with reference to FIG. 2 can be directed to examples in which the aid vehicle performs actual corrective actions itself in aid of the distressed vehicle. However, in some examples, the aid vehicle can additionally or alternatively automatically provide information to one or more third parties that can be used by those third parties in performing corrective actions to aid the distressed vehicle. FIG. 3 illustrates an exemplary method 300 of an aid vehicle providing, to one or more third parties, relevant information for assisting a distressed vehicle according to examples of the disclosure. Method 300, and the examples of the disclosure, will be described in the context of a single aid vehicle and a single distressed vehicle; however, it is understood that the examples of the disclosure can apply analogously to multiple aid vehicles and/or multiple distressed vehicles. At step 302, the aid vehicle can determine that one or more other vehicles are in need of assistance, such as described with reference to FIG. 2.

At step 304, the aid vehicle can determine one or more trouble items associated with the distressed vehicle, such as described with reference to FIG. 2. Additionally or alternatively to the examples described with reference to FIG. 2, in some examples, at step 304, the aid vehicle can determine the status of one or more occupants of the distressed vehicle (e.g., using cameras/sensors on the aid vehicle, or based on information received from the distressed vehicle and/or its cameras/sensors). For example, the aid vehicle can determine if one or more occupants of the distressed vehicle are conscious or unconscious (e.g., using one or more cameras/sensors included in the aid vehicle or the distressed vehicle), the number of occupants in the distressed vehicle (e.g., using one or more cameras/sensors included in the aid vehicle or the distressed vehicle), the blood pressure or other medical statistics of one or more occupants of the distressed vehicle (e.g., using one or more sensors in fitness accessories or smartwatches worn by the occupants), the blood type or other medical conditions of one or more occupants of the distressed vehicle (e.g., via fitness accessories and/or other information stored by electronic devices associated with the occupants), and the general state of being of the one or more occupants (e.g., using the aid vehicle's own cameras/sensors to determine injuries to the occupants of the distressed vehicle). In some examples, the aid vehicle can identify certain characteristics about the distressed vehicle at step 304 that are indicative of the damage to the distressed vehicle. For example, the aid vehicle can identify what parts of the distressed vehicle are damaged, and the extent of the damage.

At step 306, the aid vehicle can record information that is indicative of the state of the distressed vehicle and/or its occupants. For example, the aid vehicle can record information indicative of the conditions described with reference to step 304. Additionally or alternatively, the aid vehicle can automatically record audio/video/images of the scene of the distressed vehicle (e.g., the scene of the accident), of the distressed vehicle and/or of the occupants of the distressed vehicle. In some examples, the aid vehicle can record information (e.g., identifying information) about the occupants of the distressed vehicle, such as who was in the distressed vehicle, and who owns the distressed vehicle; in some examples, the distressed vehicle can provide such information to the aid vehicle, because the distressed vehicle can have access to biometric and/or electronic information pertaining to the above (e.g., data from a phone that is paired with the distressed vehicle, stored biometric information on the distressed vehicle, etc.). In some examples, the aid vehicle can record the type of vehicle that the distressed vehicle is, such as whether it is a gasoline-powered vehicle, a motorcycle, a sedan, etc. In some examples, the aid vehicle can record the weather at the location of the distressed vehicle. In some examples, a person at the location of the distressed vehicle can enter, into the aid vehicle, information about the distressed vehicle, such as the number of people injured, their injuries, how they were injured, etc.

At step 308, the aid vehicle can automatically communicate the information it recorded at step 306 to an appropriate third party, such as a gas station (e.g., in the case that the distressed vehicle has run out of gas) or emergency responders (e.g., in the case that occupants of the distressed vehicle are injured). For example, if the distressed vehicle has run out of gas, the aid vehicle can transmit a message to a proximate gas station or other roadside assistance service that gas is needed at the location of the distressed vehicle, and the gas station can arrange for delivery of gas to the distressed vehicle. As another example, the aid vehicle can automatically contact emergency responders and provide them with details of the location of the distressed vehicle, its condition, the condition of its occupants, etc. In some examples, the aid vehicle can transmit images/video/audio of the distressed vehicle and its environment (e.g., the scene of the accident, the weather, etc.) to emergency responders so that the responders can be better prepared to provide the assistance necessary when they arrive. In some examples, the aid vehicle can transmit any relevant information recorded at step 306 to emergency responders, and can, for example, attach the GPS coordinates of the aid vehicle and/or the distressed vehicle to such transmissions. In some examples, the aid vehicle can transmit information about occupants of the distressed vehicle, as discussed above, to emergency responders so that the responders have information about identities, medical conditions/statistics, etc., before arriving at the scene of the distressed vehicle. In some examples, the aid vehicle can allow emergency responders (or another appropriate third party) to control its cameras or other sensors (e.g., control their direction), and can transmit images or data from those cameras or other sensors to the emergency responders to allow the emergency responders to survey the distressed vehicle and its surroundings before arriving at the scene. In some examples, a camera associated with a vehicle (e.g., the aid vehicle, the distressed vehicle) can assist in determining whether a victim may be a potential organ donor candidate. For example, if a camera and an associated system can determine that a victim was decapitated, or otherwise suffered severe brain damage (or otherwise is unlikely to survive), an emergency responder, hospital, organ donor organization, or other party may be notified by, for example, the aid vehicle. The aid vehicle can additionally notify the third party of the victim's name (or other identifying information), and can also notify the third party of the kinds of injuries the victim suffered so that the third party can attempt to determine what organs are most likely to be available (undamaged) for donation. In some examples, an aid vehicle may receive information from one or more cameras coupled with/attached to an unmanned aerial vehicle (e.g., a drone), and may use the information received from the cameras as described herein (e.g., to send one or more images to a third party such as emergency responders). In some examples, via cameras on the aid vehicle, emergency responders may be able to determine that a certain road for accessing the distressed vehicle is blocked due to some condition, and the aid vehicle can help the emergency responders determine an alternate route to reach the distressed vehicle. In some examples, the aid vehicle can allow emergency responders (or another appropriate third party) to communicate with people at the scene of the distressed vehicle (e.g., via a display and/or speakers on the aid vehicle) to, for example, provide guidance to those people about how to respond to the distressed vehicle. For example, the emergency responders can instruct people in the surroundings of the aid vehicle to perform certain medical procedures or treatment on those who may be injured at the scene of the distressed vehicle.

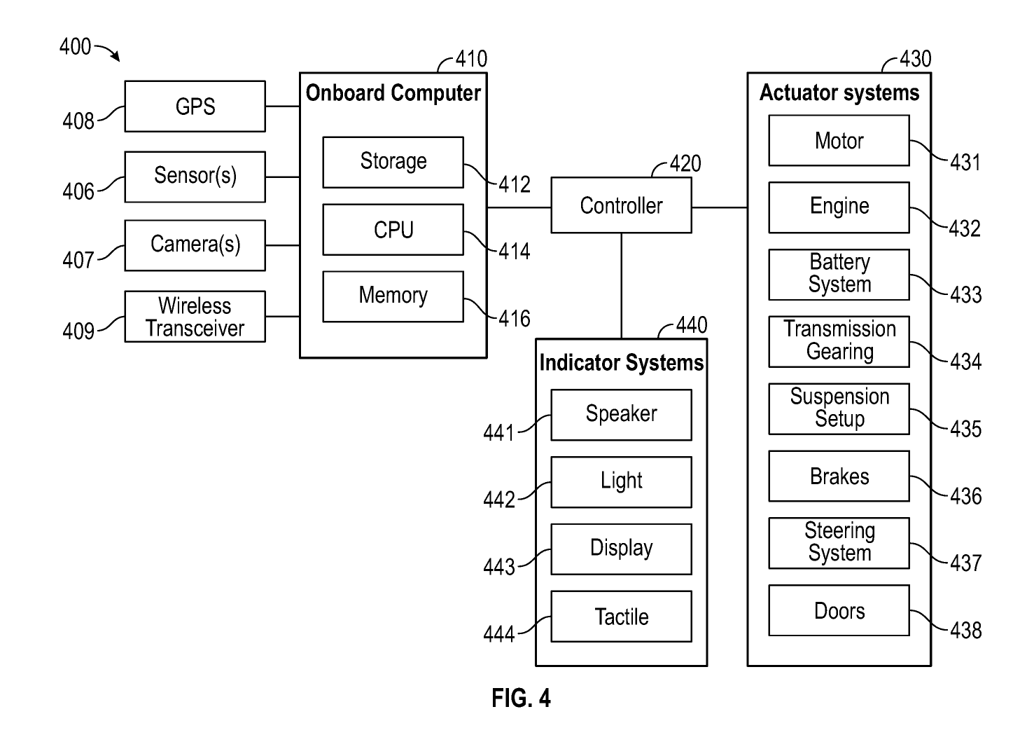

FIG. 4 illustrates an exemplary system block diagram of vehicle control system 400 according to examples of the disclosure. Vehicle control system 400 can perform any of the methods described with reference to FIGS. 1-3. System 400 can be incorporated into a vehicle, such as a consumer automobile. Other example vehicles that may incorporate the system 400 include, without limitation, airplanes, boats, or industrial automobiles. Vehicle control system 400 can include one or more cameras 406 capable of capturing image data (e.g., video data) of the vehicle's surroundings, as described with reference to FIGS. 1-3. Vehicle control system 400 can also include one or more other sensors 407 (e.g., radar, ultrasonic, LiDAR, etc.) capable of detecting various characteristics of the vehicle's surroundings, a Global Positioning System (GPS) receiver 408 capable of determining the location of the vehicle, and a wireless transceiver 409 capable of transmitting and receiving wireless communications (e.g., to or from other vehicles, third parties, etc.). Vehicle control system 400 can include an on-board computer 410 that is coupled to the cameras 406, sensors 407, GPS receiver 408 and wireless transceiver 409, and that is capable of receiving the image data from the cameras 406, outputs from the sensors 407, the GPS receiver 408 and the wireless transceiver 409, and capable of providing inputs to the wireless transceiver 409 for transmitting information. The on-board computer 410 can be capable of automatically identifying one or more distressed vehicles and performing appropriate actions in response, as described in this disclosure. On-board computer 410 can include storage 412, memory 416, and a processor 414. Processor 414 can perform any of the methods described with reference to FIGS. 1-3. Additionally, storage 412 and/or memory 416 can store data and instructions for performing any of the methods described with reference to FIGS. 1-3. Storage 412 and/or memory 416 can be any non-transitory computer readable storage medium, such as a solid-state drive or a hard disk drive, among other possibilities. The vehicle control system 400 can also include a controller 420 capable of controlling one or more aspects of vehicle operation, such as taking corrective action to assist a distressed vehicle as determined by the on-board computer 410.

In some examples, the vehicle control system 400 can be connected to (e.g., via controller 420) one or more actuator systems 430 in the vehicle and one or more indicator systems 440 in the vehicle. The one or more actuator systems 430 can include, but are not limited to, a motor 431 or engine 432, battery system 433, transmission gearing 434, suspension setup 435, brakes 436, steering system 437 and door system 438. The vehicle control system 400 can control, via controller 420, one or more of these actuator systems 430 during vehicle operation; for example, to open or close one or more of the doors of the vehicle using the door actuator system 438, to control the vehicle during autonomous driving or parking operations using the motor 431 or engine 432, battery system 433, transmission gearing 434, suspension setup 435, brakes 436 and/or steering system 437, to provide appropriate assistance to a distressed vehicle, etc. The one or more indicator systems 440 can include, but are not limited to, one or more speakers 441 in the vehicle (e.g., as part of an entertainment system in the vehicle), one or more lights 442 in the vehicle, one or more displays 443 in the vehicle (e.g., as part of a control or entertainment system in the vehicle) and one or more tactile actuators 444 in the vehicle (e.g., as part of a steering wheel or seat in the vehicle). The vehicle control system 400 can control, via controller 420, one or more of these indicator systems 440 to provide indications to one or more persons relating to one or more distressed vehicles as determined by the on-board computer 410, such as instructions on how to repair a distressed vehicle.

Thus, the examples of the disclosure provide various ways for a vehicle to autonomously and/or automatically identify one or more distressed vehicles, and provide appropriate assistance to those distressed vehicles and/or their occupants.

Therefore, according to the above, some examples of the disclosure are directed to a first vehicle comprising: one or more sensors configured to sense one or more characteristics of surroundings of the first vehicle; one or more cameras configured to capture images of the surroundings of the first vehicle; and one or more processors coupled to the one or more sensors and the one or more cameras, the one or more processors configured to: identify a second vehicle as a distressed vehicle using outputs from at least one of the one or more sensors and the one or more cameras; determine one or more trouble items associated with the distressed vehicle; and in response to determining the one or more trouble items, perform a set of one or more actions to assist the distressed vehicle based on the determined one or more trouble items. Additionally or alternatively to one or more of the examples disclosed above, in some examples, performing the set of actions to assist the distressed vehicle comprises: n accordance with a determination that the one or more trouble items are of a first type, performing an action to remedy the one or more trouble items; and in accordance with a determination that the one or more trouble items are of a second type, transmitting information to a third party for remedying the one or more trouble items. Additionally or alternatively to one or more of the examples disclosed above, in some examples, performing the set of actions to assist the distressed vehicle comprises: in accordance with a determination that the first vehicle is capable of remedying the one or more trouble items, performing an action to remedy the one or more trouble items; and in accordance with a determination that the first vehicle is not capable of remedying the one or more trouble items, transmitting information to a third party for remedying the one or more trouble items. Additionally or alternatively to one or more of the examples disclosed above, in some examples, performing the set of actions to assist the distressed vehicle comprises: determining a destination set in a navigation system of the distressed vehicle; and offering to drive, with the first vehicle, one or more occupants of the distressed vehicle to the destination set in the navigation system of the distressed vehicle. Additionally or alternatively to one or more of the examples disclosed above, in some examples, performing the set of actions to assist the distressed vehicle comprises transmitting information about the one or more trouble items to a third party. Additionally or alternatively to one or more of the examples disclosed above, in some examples, the information comprises video, audio or images of the distressed vehicle captured by the one or more cameras, and the third party comprises an emergency responder. Additionally or alternatively to one or more of the examples disclosed above, in some examples, the one or more processors are further configured to transmit, to the third party, GPS location information for the first vehicle with the information about the one or more trouble items. Additionally or alternatively to one or more of the examples disclosed above, in some examples, the one or more trouble items include a nonoperational component on the distressed vehicle, and performing the set of actions to assist the distressed vehicle comprises providing instructions for repairing the nonoperational component of the distressed vehicle. Additionally or alternatively to one or more of the examples disclosed above, in some examples, determining the one or more trouble items associated with the distressed vehicle includes determining one or more damaged components of the distressed vehicle. Additionally or alternatively to one or more of the examples disclosed above, in some examples, determining the one or more trouble items associated with the distressed vehicle includes determining a state of one or more occupants of the distressed vehicle. Additionally or alternatively to one or more of the examples disclosed above, in some examples, identifying the second vehicle as distressed includes identifying the second vehicle as distressed based on a communication received from the second vehicle. Additionally or alternatively to one or more of the examples disclosed above, in some examples, determining the one or more trouble items associated with the distressed vehicle is based on communication between the first vehicle and the distressed vehicle. Additionally or alternatively to one or more of the examples disclosed above, in some examples, the first vehicle determines the one or more trouble items associated with the distressed vehicle by accessing an ECU of the distressed vehicle. Additionally or alternatively to one or more of the examples disclosed above, in some examples, performing the set of actions to assist the distressed vehicle comprises transmitting information about one or more occupants of the distressed vehicle to a third party. Additionally or alternatively to one or more of the examples disclosed above, in some examples, the first vehicle determines the information about the one or more occupants of the distressed vehicle based on communication between the first vehicle and the distressed vehicle. Additionally or alternatively to one or more of the examples disclosed above, in some examples, the first vehicle determines the information about the one or more occupants of the distressed vehicle based on communication between the first vehicle and one or more electronic devices associated with the one or more occupants of the distressed vehicle. Additionally or alternatively to one or more of the examples disclosed above, in some examples, determining the one or more trouble items associated with the distressed vehicle includes determining that one or more systems in the distressed vehicle are operating dangerously, and performing the set of actions to assist the distressed vehicle comprises transmitting one or more commands to the distressed vehicle to cease operation of the one or more systems. Additionally or alternatively to one or more of the examples disclosed above, in some examples, performing the set of actions to assist the distressed vehicle comprises allowing one or more occupants of the distressed vehicle to communicate with a third party using the first vehicle.

Some examples of the disclosure are directed to a method comprising: identifying a vehicle as a distressed vehicle using outputs from at least one of one or more sensors and one or more cameras; determining one or more trouble items associated with the distressed vehicle; and in response to determining the one or more trouble items, performing a set of one or more actions to assist the distressed vehicle based on the determined one or more trouble items.

Some examples of the disclosure are directed to a non-transitory computer-readable medium including instructions, which when executed by one or more processors, cause the one or more processors to perform a method comprising: identifying a vehicle as a distressed vehicle using outputs from at least one of one or more sensors and one or more cameras; determining one or more trouble items associated with the distressed vehicle; and in response to determining the one or more trouble items, performing a set of one or more actions to assist the distressed vehicle based on the determined one or more trouble items.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A first vehicle comprising:
one or more sensors configured to sense one or more characteristics of surroundings of the first vehicle;
one or more cameras configured to capture images of the surroundings of the first vehicle; and
one or more processors coupled to the one or more sensors and the one or more cameras, the one or more processors configured to:
identify a second vehicle as a distressed vehicle using outputs from at least one of the one or more sensors and the one or more cameras;
determine one or more trouble items associated with the distressed vehicle; and
in response to determining the one or more trouble items, perform a set of one or more actions to assist the distressed vehicle based on the determined one or more trouble items.

2. The first vehicle of claim 1, wherein performing the set of actions to assist the distressed vehicle comprises:
in accordance with a determination that the one or more trouble items are of a first type, performing an action to remedy the one or more trouble items; and
in accordance with a determination that the one or more trouble items are of a second type, transmitting information to a third party for remedying the one or more trouble items.

3. The first vehicle of claim 1, wherein performing the set of actions to assist the distressed vehicle comprises:
in accordance with a determination that the first vehicle is capable of remedying the one or more trouble items, performing an action to remedy the one or more trouble items; and
in accordance with a determination that the first vehicle is not capable of remedying the one or more trouble items, transmitting information to a third party for remedying the one or more trouble items.

4. The first vehicle of claim 1, wherein performing the set of actions to assist the distressed vehicle comprises:
determining a destination set in a navigation system of the distressed vehicle; and
offering to drive, with the first vehicle, one or more occupants of the distressed vehicle to the destination set in the navigation system of the distressed vehicle.

5. The first vehicle of claim 1, wherein performing the set of actions to assist the distressed vehicle comprises transmitting information about the one or more trouble items to a third party.

6. The first vehicle of claim 5, wherein the information comprises video, audio or images of the distressed vehicle captured by the one or more cameras, and the third party comprises an emergency responder.

7. The first vehicle of claim 5, wherein the one or more processors are further configured to transmit, to the third party, GPS location information for the first vehicle with the information about the one or more trouble items.

8. The first vehicle of claim 1, wherein:
the one or more trouble items include a nonoperational component on the distressed vehicle, and
performing the set of actions to assist the distressed vehicle comprises providing instructions for repairing the nonoperational component of the distressed vehicle.

9. The first vehicle of claim 1, wherein determining the one or more trouble items associated with the distressed vehicle includes determining one or more damaged components of the distressed vehicle.

10. The first vehicle of claim 1, wherein determining the one or more trouble items associated with the distressed vehicle includes determining a state of one or more occupants of the distressed vehicle.

11. The first vehicle of claim 1, wherein identifying the second vehicle as distressed includes identifying the second vehicle as distressed based on a communication received from the second vehicle.

12. The first vehicle of claim 1, wherein determining the one or more trouble items associated with the distressed vehicle is based on communication between the first vehicle and the distressed vehicle.

13. The first vehicle of claim 12, wherein the first vehicle determines the one or more trouble items associated with the distressed vehicle by accessing an ECU of the distressed vehicle.

14. The first vehicle of claim 1, wherein performing the set of actions to assist the distressed vehicle comprises transmitting information about one or more occupants of the distressed vehicle to a third party.

15. The first vehicle of claim 14, wherein the first vehicle determines the information about the one or more occupants of the distressed vehicle based on communication between the first vehicle and the distressed vehicle.

16. The first vehicle of claim 14, wherein the first vehicle determines the information about the one or more occupants of the distressed vehicle based on communication between the first vehicle and one or more electronic devices associated with the one or more occupants of the distressed vehicle.

17. The first vehicle of claim 1, wherein:
determining the one or more trouble items associated with the distressed vehicle includes determining that one or more systems in the distressed vehicle are operating dangerously, and
performing the set of actions to assist the distressed vehicle comprises transmitting one or more commands to the distressed vehicle to cease operation of the one or more systems.

18. The first vehicle of claim 1, wherein performing the set of actions to assist the distressed vehicle comprises allowing one or more occupants of the distressed vehicle to communicate with a third party using the first vehicle.

19. A method comprising:
identifying a vehicle as a distressed vehicle using outputs from at least one of one or more sensors and one or more cameras;
determining one or more trouble items associated with the distressed vehicle; and
in response to determining the one or more trouble items, performing a set of one or more actions to assist the distressed vehicle based on the determined one or more trouble items.

20. A non-transitory computer-readable medium including instructions, which when executed by one or more processors, cause the one or more processors to perform a method comprising:
identifying a vehicle as a distressed vehicle using outputs from at least one of one or more sensors and one or more cameras;
determining one or more trouble items associated with the distressed vehicle; and
in response to determining the one or more trouble items, performing a set of one or more actions to assist the distressed vehicle based on the determined one or more trouble items.
